(19) United States
(12) Patent Application Publication
(10) Pub. No.: US 2006/0111924 A1
(43) Pub. Date: May 25, 2006

(54) Method and system for warranty claim processing

(76) Inventors: Franz Hollich, Sinsheim (DE); Harald Kluge, Sinsheim (DE)

Correspondence Address: KENYON & KENYON LLP, 1500 K STREET N.W., SUITE 700, WASHINGTON, DC, 20005, US

(21) Appl. No.: 11/026,058

(22) Filed: Jan. 3, 2005

Related U.S. Application Data
(60) Provisional application No. 60/630,299, filed on Nov. 24, 2004.

(51) Int. Cl. G06Q 99/00

(52) U.S. Cl. 705/1

(57) ABSTRACT

A method and system for processing a warranty claim generated on the basis of a service order. A warranty relating to the service order is checked. On the basis of the data included in the service order, warranty data is found and a determination is made as to whether a warranty claim is necessary. A warranty claim and a case (business transaction type) are created/update by copying or by transferring data relating the claimant and/or reimburser from the service order via an interface. The case is created to store information in a database about all business transactions and documents related with the warranty claim. The warranty case facilitates management of the warranty claim. A warranty check process is performed for purposes of warranty relevance and, if necessary, the warranty claim items are split into more that one warranty claim. As a result of the checking process, the new warranty claim is accepted, automatically corrected, passed on for manual processing or rejected.

### BACKGROUND INFORMATION

Data processing systems may be used to handle various types of data. Such systems may process warranty claims regarding various products. The demands on warranty processing system continue to increase because the requirements for making a warranty claim are becoming increasingly complex and extensive. Warranty restrictions depending on operating performance or age of products, authorization procedures, the high number of incoming warranty claims, as well as extensive checking mechanisms make warranty claim processing time-consuming and costly.

### BRIEF DESCRIPTION OF THE DRAWINGS

FIG. 1 shows an exemplary embodiment of a system of the present invention.

FIG. 2 shows an exemplary embodiment of a method of the present invention.

FIG. 3 shows another exemplary embodiment of a method of the present invention.

### DETAILED DESCRIPTION

The systems and methods of the present invention provide for warranty claim record processing. Furthermore, the systems and methods of the present invention may be used by dealers, reimbursers such as manufacturers, importers, sales companies, and suppliers, and claimants (consumers). A warranty claim record is created in a computer system on the basis of a request for reimbursement of material, labor and external service costs that are incurred for the purpose of rectifying faults in a product. A manufacturer may sell various products and provide consumers with warranties relating to the products. For example, a consumer may purchase a washing machine from a manufacturer that provides the consumer with a warranty covering defects and repairs relating to the washing machine for a certain period of time or indefinitely. Warranty claims may be related to various criteria such as operating hours for products, mileage for the products, measuring documents for the products, contracts in conjunction with the products (service and warranty contracts, master warranties), catalog entries (such as defect code) and special rules for the warranty such as an extended warranty or goodwill. The warranty claim records may be sent automatically to the various reimburser(s) (manufactures, suppliers, etc.) and may then be processed once they have been checked and returned by the reimburser(s). Any decisions indicating that the dealer does not accept the claim or any corrected warranty claims may be sent back to the reimburser(s) immediately. Once warranty claim record processing is complete, the systems and methods of the present invention may provide its data to a customer relationship system that generates an overview of the total costs and revenues associated with warranty claim record processing.

According to the present invention, warranty claim record processing enables users to process a high volume of warranty claim records conveniently and to a large extent automatically. Warranty claim records are processed manually only when the automatic checks produce negative results. Warranty claim records may be created manually by copying and/or by transferring data from the claimant (consumer) an/or or reimburser via an interface. Additionally, the present invention provides an interface for warranty claim record processing that may allow dealers to submit a warranty claim record (on behalf of a consumer) to a reimburser that checks the claim and returns a warranty claim assessment record to the claimant. The warranty claim assessment indicates the determination of the reimburser as to whether a reimbursement is to be made and the monetary extent of the reimbursement.

Also, the present invention may be used to define different warranty claims that are mapped and handled by different transaction types. A warranty claim record is defined by a transaction type that specifies the business nature and terms of the warranty. Every warranty claim transaction type has its own data, such as data relating to a business partner, and contains one or more items. Warranty claim transaction types help create a clearly arranged graphical user interface. Warranty claims of a specific transaction type are displayed under a certain category in a navigation tree in the graphical user interface. For example, all warranty claims that are transferred to the reimburser by the system are grouped and displayed together. Examples of different transaction types include: versions from claimant for warranty claims sent by the claimant, versions to reimburser for warranty claims that have already undergone certain checks and that are forwarded to the reimburser by the system, and versions from reimburser for warranty claims returned by the reimburser which have been approved or rejected.

The data structure of a warranty claim record includes a header containing data (warranty claim number, object number, reference data, etc.) that is the same in all follow-up documents of the warranty claim record. The present invention generates follow-up documents for this warranty claim record that contain information for and about the warranty partner. The warranty claim record contains specific items for each partner. All the follow-up documents of a warranty claim record have a unique identification number. Warranty data such as labor values (wages) parts (materials) and other activities (invoices for third-party activities such as hotel bills, expenses) are listed at the item level for which different item categories exist. The systems and methods of the present invention assign a unique number to each item and provide that an item type (labor, parts, other) exists for each activity. Depending on the item type selected, suitable input fields are displayed in warranty claim interface presented to a user.

According to the present invention, the warranty claim record may include header data, an unique identification number, product name, claimant name, reimburser name, claim number, transaction (case) type, product value, warranty coverage data, other warranty data, etc.

According to the present invention, a service order requesting a product and warranty claim data relating to the product are used in conjunction in a customer relationship management system for purposes of warranty claim record processing. Warranty claim records may be created manually and/or automatically from the service order even if each warranty claim record contains several items and/or relates to several products. The present invention may process warranty claim records without reference to a service order. The service order and the warranty claim record share the same data model such that a warranty claim record is mapped and stored in a database on the basis of its header and data items. The elements of the warranty claim record are mapped on the basis of business transaction type. The warranty claim records are grouped and stored together by a business transaction (warranty case).

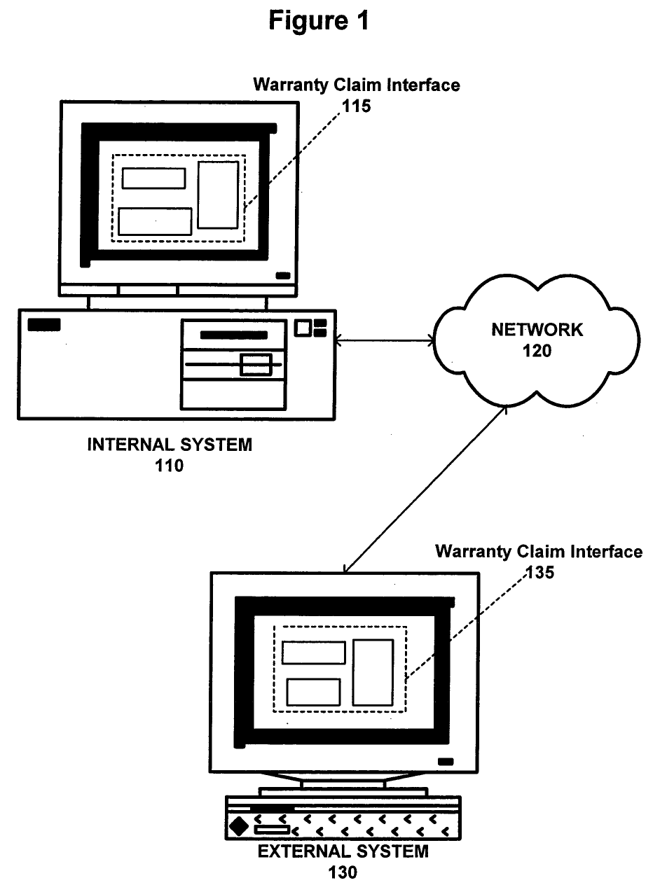

FIG. 1 shows an exemplary system according to the present invention. The system includes an internal system 110, a network 120, and an external system 130. The internal system 110 may be used by a claimant and the external system may 130 be used by a reimburser. The internal system 110 and the external system 130 both include a database systems which may be any type of computer readable medium, such as one or more hard disk memories, that stores instructions and data for a knowledge warehouse system that maintains a collection of data to support a decision making process. The internal system 110 and the external system 130 may be any type of device for running application software, such as for example a personal computer, a terminal, a personal digital assistant (PDA), a terminal server, mainframe computer, any type of computer system, etc. Network 120 may be any type of network for communicating information, such as a local area network (LAN), wide area network (WAN), the Internet, or an Intranet. Typically, many internal systems may be coupled to many external systems through network 120. Additionally, both the internal system 110 and the external system 130 may include a customer relationship management (CRM) system.

As shown in FIG. 1, the internal system 110 is displaying a warranty claim interface 115, which contains a plurality of fields. In some embodiments, a user running a warranty claim application program on internal system 110 may be prompted to enter information into data entry fields in the warranty claim interface 115. The external system 130 displays its own warranty claim interface 135. Both interfaces 115, 135 provide a user interface for processing warranty claim records manually and/or automatically, for data administration, and for communication between the warranty claimants and reimbursers. The present invention provides for warranty claim record templates that are displayed via the interfaces 115, 135.

In an exemplary embodiment of the present invention, after the warranty claim record is completed via the interface 115, warranty claim data is sent by a user from the internal system 110 (by a warranty claimant such as a customer and/or a dealer) to the external system 130 for processing by at least one reimburser (manufacturer, supplier, etc.). In the external system 130, data submitted via the warranty claim record is processed and checked and then a decision indicating that the warranty claim record is accepted, rejected, or corrected is sent back to the internal system 110. Warranty claim data may be transmitted via e-mail and/or another data transmission method on communication network 120. Once warranty claim record processing is complete, the systems and methods of the present invention may provide its data to a customer relationship system that generates an overview of the total costs and revenues associated with warranty claim record processing.

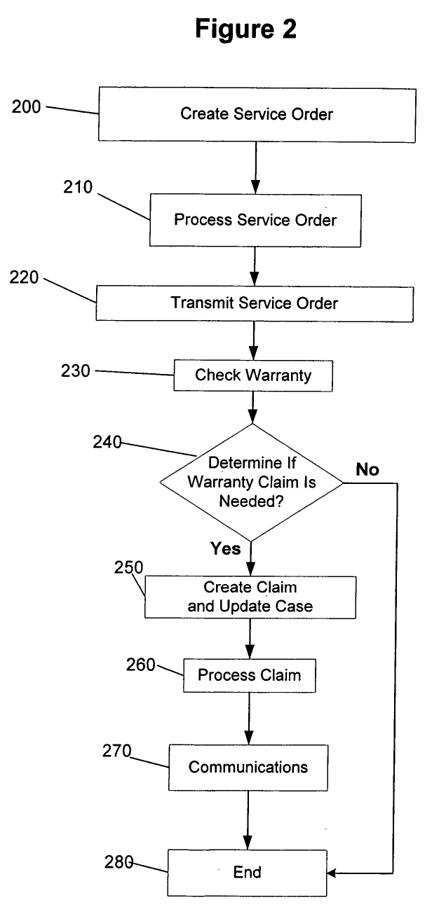

FIG. 2 shows an exemplary embodiment of a method according to the present invention. The method of FIG. 2 may be performed on the system of FIG. 1. The method of FIG. 2 handles a warranty claim record generated on the basis of a service order. In step 200, a service order is created. The service order includes data relating to a product purchase such a date of purchase, cost, customer, dealer, manufacturer, etc. Then in step 210, the service order is processed such that the data contained in the service order is stored in a database of the internal system 110 and/or external system 130. In step 220, the service order is transmitted from the internal system 110 to the external system 130 via the communications network 120, e.g., via e-mail. A user, such as customer or product dealer, sends the service order via the internal system 110 to a reimburser, such as a manufacturer or supplier. Next, a warranty data relating to the service order is checked in step 230. On the basis of the data included in the service order, warranty data is found on a database of the internal system 110 and/or external system 130. A determination is made in step 240 as to whether a warranty claim record is necessary. The data of the service order and warranty claim record are used to make this determination. On the basis of such service order data such as the purchase date, a warranty claim record may or may not be needed because the product may or may not still be covered under the warranty. Additionally, the product may have never been covered by a warranty. If a warranty claim record is not needed, the method of the present invention ends in step 280.

When a warranty claim record is needed, step 250 is performed such that a warranty claim record and a case (business transaction type) are created/update by copying and/or by transferring data relating to the claimant and/or reimburser from the service order via the interface 115, 135. The case is created in order to store information in the database regarding all business transactions and documents related to the warranty claim record. The use of warranty cases may facilitate the management and storage of the warranty claim record in a database of a computer system. The present invention creates a new case when the new created warranty claim record is not related with at least one of the already existing warranty claim records. The warranty case is updated on the basis of any business transaction related to the warranty claim record. According to the present invention, a warranty case specifies the business partner(s) involved with the product and its warranty. Hence, the system of the present invention maps different warranty claim records on the basis of warranty cases. This mapping may be executed via a database.

Several warranty claim records may be created from one service order, e.g., more than one product was purchased via the service order. The data structure of a warranty claim record may include a header containing data (warranty claim number, object number, reference data, etc.) that is the same in all follow-up documents of the warranty claim record. The present invention generates follow-up documents for this warranty claim record that contain information for the warranty partner and about the warranty partner. The warranty claim record contains specific items for each partner. All the follow-up documents of a warranty claim record have a unique identification number. Warranty data such as labor values (wages), parts (materials) and other activities (invoices for third-party activities such as hotel bills, expenses) are listed at the item level for which different item categories exist. The systems and methods of the present invention assign a unique number to each item and provide that an item type (labor, parts, other) exists for each activity. Depending on the item type selected by a user, appropriate data input fields are displayed in warranty claim interface 115, 135 presented to a user. The service order and the warranty claim record share the same data model such that a warranty claim record is mapped and stored in a database, of internal system 110 and/or external system 130, on the basis of a header and items of the warranty claim record. The elements of the warranty claim record are mapped on the basis of case (business transaction type). Various warranty claim records are grouped and stored together in the database by a case (business transaction type). Also, the present invention provides for definition of different warranty claim records that are mapped and handled by different cases (business transaction types). A warranty claim record is defined by a case (transaction type) which specifies the business partners related to the warranty. Every warranty claim type has its own data, such as data relating to a business partner, and contains one or more items. Warranty claim cases (transaction types) help create a clearly arranged user interface 115, 135. Warranty claim records of a specific transaction type are displayed under a certain category in a navigation tree on the user interface 115, 135. For example, all warranty claim records that are transferred to the reimburser by the system are grouped and displayed together. Examples of different cases (business transaction types) include: versions from claimant for warranty claims sent by the claimant, versions to reimburser for warranty claims that have already undergone certain checks and that are forwarded to the reimburser by the system, and versions from reimburser for warranty claims returned by the reimburser which have been approved or rejected.

In step 260, the warranty claim record is processed such that the warranty claim record is checked. All items of the warranty claim record are checked for warranty relevance and, if necessary, the warranty claim record items are split into more that one warranty claim record. Whether the warranty claim record is split depends on whether one or more reimbursers are responsible for the entitlements of one or more items from the warranty claim. A new warranty claim record with various items is created for each partner. The new warranty claim records are sent to the reimbursers via an interface 115, 135. As a result of the checking process in step 260, the new warranty claim record is accepted, automatically corrected, passed on for manual processing or rejected. After manual processing, each warranty claim record may be sent back to the partner for repeat processing. The rules of the checking process may be defined by the reimburser in order to decide how to process the new warranty claim record. The present invention provides for checking warranty claim records and warranty cases (business transaction types). The purpose of checking the warranty claim is to provide an assessment of warranties with regard to the potential amount of reimbursements. Additionally, the role of checking rules in warranty claim record processing is to check (wherever possible, automatically) the validity of the data that has been entered relating to the warranty claim record and to replace specific data (substitution) before the data is updated in the database(s) of the systems 110, 130.

Next in step 270, communication between the warranty claimant (e.g., customer or dealer) on the internal system 110 and the reimburser (e.g., dealer or supplier) on the external system 130 is conducted via the communications network 120. After warranty claim record checking is completed in step 260, the warranty claim record contains the reimburser's assessment, the monetary share that the partner intends assuming, and/or a rejection indicator including a rejection code. The reimburser may also use the rejection code to indicate that the warranty claim record is incomplete and request its completion. The warranty assessment and/or rejection code may be transmitted via the communication network to the claimant. At this point, the claimant is notified of the assessment and/or reject-code via the internal system 110. If the assessment of the reimburser indicates that the warranty claim record is valid and that the reimburser is providing compensation, the claimant may accept the assessment and close the warranty claim process. If the reimburser accepts the warranty claim record submitted by the claimant, the system closes warranty claim record processing by grouping accepted warranty claim records together into one record. This warranty claim record is then sent in one document to the claimant and/or displayed on the interface 115 with the service order. If the assessment and/or rejection code indicates that the warranty claim needs to be corrected, the claimant may correct the warranty claim record automatically and create a new follow-up warranty claim document. When warranty claim records are corrected automatically or manually by the claimant on the internal system 110, the present invention creates a new, corrected warranty claim record that is automatically sent to the reimburser via the systems 110, 130 and the communications network 120. If the reimburser does not accept the warranty claim record or if the version processed by the reimburser is not accepted after warranty checks have been performed, a new warranty claim record may be created and either sent back to the reimburser or forwarded for manual processing. In manual processing, a claimant may decide whether to accept or reject the reimbuser's assessment. If necessary, the present invention creates several follow-up documents for a warranty claim record that are sent to the reimburser for processing.

In step 280, the method of the present invention is complete and ends.

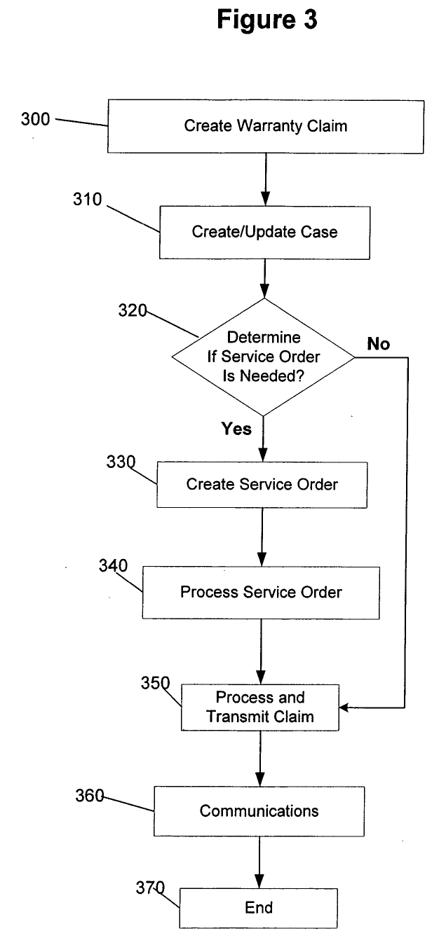

FIG. 3 shows another exemplary embodiment of a method according to the present invention. The method of FIG. 3 may be performed on the system in FIG. 1. The method of FIG. 3 handles a warranty claim record generated only on the basis of the warranty claim record. In step 300, a warranty claim record is created. Then in step 310, a warranty case is created. The warranty claim record and the case (business transaction type) are created by copying or by transferring data relating the claimant and/or reimburser via the interface 115, 135. The data structure of a warranty claim record may include a header containing data (warranty claim number, object number, reference data, etc.) that is the same in all follow-up documents of the warranty claim record. The present invention generates follow-up documents for this warranty claim record that contain information for and about the warranty partner. The warranty claim record contains specific items for each partner. All the follow-up documents of a warranty claim record have a unique identification number. Warranty data such as labor values (wages), parts (materials) and other activities (invoices for third-party activities such as hotel bills, expenses) are listed at the item level for which different item categories exist. The systems and methods of the present invention assign a unique number to each item and provide that an item type (labor, parts, other) exists for each activity. Depending on the item type selected, suitable input fields are displayed in warranty claim interface 115, 135 presented to a user. The service order and the warranty claim record share the same data model such that a warranty claim record is mapped and stored in a database, of internal system 110 and/or external system 130, on the basis of a header and items of the warranty claim record. The elements of the warranty claim record are mapped on the basis of case (business transaction type). Various warranty claim records are grouped and stored together in the database by a case (business transaction type). Also, the present invention provides for definition of different warranty claim records that are mapped and handled by different cases (business transaction types). A warranty claim record is defined by a case (transaction type) which specifies the business partners related to the warranty. Every warranty claim type has its own data, such as data relating to a business partner, and contains one or more items. Warranty claim cases (transaction types) help create a clearly arranged user interface 115, 135. Warranty claim records of a specific transaction type are displayed under a certain category in a navigation tree on the user interface 115, 135. For example, all warranty claim records that are transferred to the reimburser by the system are grouped and displayed together. Examples of different cases (business transaction types) include: versions from claimant for warranty claim records sent by the claimant, versions to reimburser for warranty claim records that have already undergone certain checks and that are forwarded to the reimburser by the system, and versions from reimburser for warranty claim records returned by the reimburser which have been approved or rejected.

In step 320, a determination is made as to whether a service order is necessary. The warranty claim data is used make this determination. On the basis of such warranty claim data such as the purchase date, a service order may or may not be needed because the product may or may not still be covered under the warranty. Additionally, the product may have never been covered by a warranty. If a service order is not needed, e.g., a service order may already exist, step 350 is performed.

When a service order is needed, step 330 is performed such that a service order is created. The service order includes data relating to a product purchase such as a date of purchase, cost, customer, dealer, manufacturer, etc. Then in step 340, the service order is processed such that the data contained in the service order is stored in a database of the internal system 110 or external system 130. The service order is processed such that it is transmitted from the internal system 110 to the external system 130 via the communications network 120. A user, such as customer or product dealer, sends the service order via the internal system 110 to a reimburser, such as a manufacturer or supplier.

Next in step 350, the warranty claim record is transmitted and processed such that warranty data relating to the warranty claim record is checked. On the basis of the data included in the service order and/or the warranty claim record, warranty data is found in a database of the internal system 110 or external system 130. All items of the warranty claim record are checked for warranty relevance and, if necessary, the warranty claim record items are split into more that one warranty claim record. As a result of the checking process in step 350, the new warranty claim record is accepted, automatically corrected, passed on for manual processing or rejected. After manual processing, each warranty claim record may be sent back to the partner for repeat processing. The rules of the checking process may be defined by the reimburser in order to decide how to process the new warranty claim record. The present invention provides for checking warranty claim classes and warranty cases (business transaction types). The purpose of checking the warranty claim record is to provide an assessment of warranties with regard to the potential amount of reimbursements. Additionally, the role of checking rules in warranty claim record processing is to check (wherever possible, automatically) the validity of the data that has been entered relating to the warranty claim record and to replace specific data (substitution) before the data is updated in the database(s) of the systems 110, 130.

Next in step 360, communication between the warranty claimant (e.g., customer or dealer) on the internal system 110 and the reimburser (e.g., dealer or supplier) on the external system 130 is conducted via the communications network 120. After warranty claim checking is completed in step 350, the warranty claim record contains the reimburser's assessment and in particular, the monetary share that the partner intends assuming, or a rejection indicator with a rejection code. The reimburser may also use the rejection code to indicate that the warranty claim record is incomplete and demand its completion. The warranty including the assessment and/or rejection code is transmitted via the communication network to the claimant. At this point, the claimant is notified of the assessment and/or reject code via the internal system 110. If the assessment of the reimburser indicates that the warranty claim record is valid and that the reimburser is providing compensation, the claimant may accept the assessment and close the warranty claim record process. If the assessment and/or rejection code indicates that the warranty claim record needs to be corrected, the claimant may correct the warranty claim record automatically and create a new follow-up warranty claim document. When warranty claim records are corrected automatically or manually by the claimant on the internal system 110, the present invention creates a new, corrected warranty claim record that is automatically sent to the reimburser via the systems 110, 130 and the communications network 120. If the reimburser does not accept the warranty claim record or if the version processed by the reimburser is not accepted after checks have been performed, new warranty claim record is created and either sent back to the reimburser or forwarded for manual processing. In manual processing, a claimant may decide whether to accept or reject the reimburser's assessment. If necessary, the present invention creates several follow-up documents for a warranty claim record that are sent to the reimburser for processing.

In step 370, the method of the present invention is complete and ends.

The method according to the present invention may be stored as a set of instructions that is accessible and executable by a processor. The processor may include a computer server arrangement. The set of instructions may be stored on a machine readable medium that us any medium capable of being read by a machine such as a compact disk, hard drive memory, floppy disk memory, DVD-ROM, CD-ROM or any type of machine-readable (computer-readable) storing medium. The set of instructions may be included within a computer program (which as is well known comprises a plurality of instructions) that is executable by a computer system.

The above is a detailed discussion of the certain embodiments. It may be understood that the examples discussed are for illustration purposes only and are not intended to limit the configuration to that shown. For example, the order of the steps performed may be varied where appropriate. It is of course intended that the scope of the claims may cover other embodiments than those described above and their equivalents.

What is claimed is:

1. A method for processing a warranty claim, the method comprising:
creating a service order record including product purchase data;
storing the service order record in a database of a computer system;
checking warranty data relating to the service order record; and
if a warranty claim is needed:
providing a warranty claim record in the database;
providing warranty case data in the database;
generating a warranty claim assessment record; and
returning the warranty claim assessment record to at least one claimant, the warranty claim assessment record being based on the warranty claim record and the warranty case data.

2. The method of claim 1, wherein the warranty claim record is at least one of created and updated at least one of manually and automatically.

3. The method of claim 1, wherein the service order record is provided to at least one reimburser.

4. The method of claim 3, wherein the warranty claim assessment record includes a determination of the at least one reimburser.

5. The method of claim 1, wherein the warranty claim record includes an identification number and data regarding at least one purchased product, a product value, at least one warranty claimant, and the at least one reimburser.

6. The method of claim 5, wherein the warranty claim record includes a reimbursement claim for rectification of faults regarding the at least one purchased product.

7. The method of claim 1, wherein the warranty claim record includes a header including a warranty claim classification and a warranty claim number.

8. The method of claim 7, wherein the warranty claim record is stored in the database as a function of the header.

9. The method of claim 1, wherein the warranty claim record is created as a function of the service order record.

10. A machine-readable medium storing a set of instructions, the set of instructions capable of being executed by a processor to implement a method for processing a warranty claim, the instructions comprising:
creating a service order record including product purchase data;
storing the service order record in a database of a computer system;
checking warranty data relating to the service order record; and
if a warranty claim is needed:
providing a warranty claim record in the database;
providing warranty case data in the database;
generating a warranty claim assessment record; and
returning the warranty claim assessment record to at least one claimant, the warranty claim assessment record being based on the warranty claim record and the warranty case data.

11. The machine-readable medium of claim 10, wherein the warranty claim record is at least one of created and updated at least one of manually and automatically.

12. The machine-readable medium of claim 10, wherein the service order record is provided to at least one reimburser.

13. The machine-readable medium of claim 12, wherein the warranty claim assessment record includes a determination of the at least one reimburser.

14. The machine-readable medium of claim 10, wherein the warranty claim record includes an identification number and data regarding at least one purchased product, a product value, at least one warranty claimant, and the at least one reimburser.

15. The machine-readable medium of claim 14, wherein the warranty claim record includes a reimbursement claim for rectification of faults regarding the at least one purchased product.

16. The machine-readable medium of claim 10, wherein the warranty claim record includes a header including a warranty claim classification and a warranty claim number.

17. The machine-readable medium of claim 16, wherein the warranty claim record is stored in the database as a function of the header.

18. The machine-readable medium of claim 10, wherein the warranty claim record is created as a function of the service order record.
